(19) United States
(12) Patent Application Publication
(10) Pub. No.: US 2023/0037632 A1
(43) Pub. Date: Feb. 9, 2023

(54) REINFORCEMENT LEARNING METHOD AND APPARATUS

(71) Applicant: HUAWEI TECHNOLOGIES CO., LTD., Shenzhen (CN)

(72) Inventors: Furui LIU, Shenzhen (CN); Wenjing CUN, Shenzhen (CN); Zhitang CHEN, Hong Kong (CN)

(21) Appl. No.: 17/966,985

(22) Filed: Oct. 17, 2022

Related U.S. Application Data
(63) Continuation of application No. PCT/CN2021/085598, filed on Apr. 6, 2021.

(30) Foreign Application Priority Data
Apr. 18, 2022 (CN) 202010308484.1

(51) Int. Cl. G06N 3/08

(52) U.S. Cl. CPC G06N 3/08

(57) ABSTRACT

A reinforcement learning method and recognition apparatus includes: obtaining a structure graph, where the structure graph includes structure information that is of an environment or the intelligent agent and that is obtained through learning; inputing a current state of the environment and the structure graph to a policy function of the intelligent agent, where the policy function is used to generate an action in response to the current state and the structure graph, and the policy function of the intelligent agent is a graph neural network; outputing the action to the environment by using the intelligent agent; obtaining, from the environment by using the intelligent agent, a next state and reward data in response to the action; training the intelligent agent through reinforcement learning based on the reward data.

### CROSS-REFERENCE TO RELATED APPLICATIONS

This application is a continuation of International Application No. PCT/CN2021/085598, filed on Apr. 6, 2021, which claims priority to Chinese Patent Application No. 202010308484.1, filed on Apr. 18, 2020. The disclosures of the aforementioned applications are hereby incorporated by reference in their entireties.

### TECHNICAL FIELD

This application relates to the field of artificial intelligence, and in particular, to a reinforcement learning method and apparatus.

### BACKGROUND

Artificial intelligence (AI) is a new technical science that studies theories, methods, techniques, and application systems for simulating, extending, and expanding human intelligence. Machine learning is the core of artificial intelligence. Machine learning methods include reinforcement learning.

In reinforcement learning, an intelligent agent (agent) performs learning in a “trial and error” manner, and a behavior of the intelligent agent is guided based on a reward (reward) obtained through interaction with an environment by using an action (action). A goal is to enable the intelligent agent to obtain maximum rewards. A policy function is a behavior rule used by the intelligent agent in reinforcement learning. The policy function is usually a neural network. The policy function of the intelligent agent usually uses a deep neural network. However, the deep neural network often encounters the problem of low learning efficiency. When there is a large quantity of parameters for training a neural network, if a limited amount of data or a limited quantity of training rounds is given, an expected gain of the policy function is relatively low. This also results in relatively low training efficiency of reinforcement learning.

Therefore, how to improve training efficiency of reinforcement learning is a problem that needs to be resolved urgently in the industry.

### SUMMARY

This application provides a reinforcement learning method and apparatus, so as to improve training efficiency of reinforcement learning.

According to a first aspect, a reinforcement learning method is provided, including: obtaining a structure graph, where the structure graph includes structure information that is of an environment or an intelligent agent and that is obtained through learning; inputting a current state of the environment and the structure graph to a policy function of the intelligent agent, where the policy function is used to generate an action in response to the current state and the structure graph, and the policy function of the intelligent agent is a graph neural network; outputting the action to the environment by using the intelligent agent; obtaining, from the environment by using the intelligent agent, a next state and reward data in response to the action; and training the intelligent agent through reinforcement learning based on the reward data.

In this embodiment of this application, a reinforcement learning model architecture is provided, which uses a graph neural network model as the policy function of the intelligent agent and obtains the structure graph of the environment or the intelligent agent through learning. In this way, the intelligent agent can interact with the environment based on the structure graph, to implement reinforcement training of the intelligent agent. In this reinforcement manner, the structure graph obtained through automatic learning and the graph neural network that is used as the policy function are combined. This can shorten a time required for finding a better solution through reinforcement learning, thereby improving training efficiency of reinforcement learning.

In this embodiment of this application, the graph neural network model is used as the policy function of the intelligent agent, and may include an understanding of an environmental structure, thereby improving efficiency of training the intelligent agent.

With reference to the first aspect, in a possible implementation of the first aspect, the obtaining a structure graph includes: obtaining historical interaction data of the environment; inputting the historical interaction data to a structure learning model; and learning the structure graph from the historical interaction data by using the structure learning model.

In this embodiment of this application, the environmental structure may be obtained from the historical interaction data by using the structure learning model, thereby automatically learning a structure of the environment. In addition, the structure graph is applied to reinforcement learning, to improve efficiency of reinforcement learning.

With reference to the first aspect, in a possible implementation of the first aspect, before the inputting the historical interaction data to a structure learning model, the method further includes: filtering the historical interaction data by using a mask, where the mask is used to eliminate impact of an action of the intelligent agent on the historical interaction data.

In this embodiment of this application, the historical interaction data may be input to the structure learning model, to obtain the structure graph. The historical interaction data is processed by using the mask, to eliminate impact of an action of the intelligent agent on observed data of the environment, thereby improving accuracy of the structure graph and improving training efficiency of reinforcement learning.

With reference to the first aspect, in a possible implementation of the first aspect, the structure learning model calculates a loss function by using the mask, the mask is used to eliminate impact of an action of the intelligent agent on the historical interaction data, and the structure learning model learns the structure graph based on the loss function.

In this embodiment of this application, the loss function in the structure learning model may be calculated by using the mask, to eliminate impact of an action of the intelligent agent on the observed data of the environment, thereby improving accuracy of the structure graph and improving training efficiency of reinforcement learning.

With reference to the first aspect, in a possible implementation of the first aspect, the structure learning model includes any one of the following: a neural interaction inference model, a Bayesian network, and a linear non-Gaussian acyclic graph model.

With reference to the first aspect, in a possible implementation of the first aspect, the environment is a robot control scenario.

With reference to the first aspect, in a possible implementation of the first aspect, the environment is a gaming environment including structure information.

With reference to the first aspect, in a possible implementation of the first aspect, the environment is a scenario of optimizing an engineering parameter of a multi-cell base station.

According to a second aspect, a reinforcement learning apparatus is provided, including: an obtaining unit, configured to obtain a structure graph, where the structure graph includes structure information that is of an environment or an intelligent agent and that is obtained through learning; an interaction unit, configured to input a current state of the environment and the structure graph to a policy function of the intelligent agent, where the policy function is used to generate an action in response to the current state and the structure graph, and the policy function of the intelligent agent is a graph neural network; the interaction unit is further configured to output the action to the environment by using the intelligent agent; and the interaction unit is further configured to obtain, from the environment by using the intelligent agent, a next state and reward data in response to the action; and a training unit, configured to train the intelligent agent through reinforcement learning based on the reward data.

Optionally, the apparatus may include a module configured to perform the method according to the first aspect.

Optionally, the apparatus is a computer system.

Optionally, the apparatus is a chip.

Optionally, the apparatus is a chip or circuit disposed in a computer system. For example, the apparatus may be referred to as an AI module.

In this embodiment of this application, a reinforcement learning model architecture is provided, which uses a graph neural network model as the policy function of the intelligent agent and obtains the structure graph of the environment or the intelligent agent through learning. In this way, the intelligent agent can interact with the environment based on the structure graph to implement reinforcement training of the intelligent agent. In this reinforcement manner, the structure graph obtained through automatic learning and the graph neural network that is used as the policy function are combined. This can shorten a time required for finding a better solution through reinforcement learning, thereby improving training efficiency of reinforcement learning.

With reference to the second aspect, in a possible implementation of the second aspect, the obtaining unit is specifically configured to obtain historical interaction data of the environment; input the historical interaction data to a structure learning model; and learn the structure graph from the historical interaction data by using the structure learning model.

With reference to the second aspect, in a possible implementation of the second aspect, the obtaining unit is further configured to filter the historical interaction data by using a mask, where the mask is used to eliminate impact of an action of the intelligent agent on the historical interaction data.

With reference to the second aspect, in a possible implementation of the second aspect, the structure learning model calculates a loss function by using the mask, the mask is used to eliminate impact of an action of the intelligent agent on the historical interaction data, and the structure learning model learns the structure graph based on the loss function.

With reference to the second aspect, in a possible implementation of the second aspect, the structure learning model includes any one of the following: a neural interaction inference model, a Bayesian network, and a linear non-Gaussian acyclic graph model.

With reference to the second aspect, in a possible implementation of the second aspect, the environment is a robot control scenario.

With reference to the second aspect, in a possible implementation of the second aspect, the environment is a gaming environment including structure information.

With reference to the second aspect, in a possible implementation of the second aspect, the environment is a scenario of optimizing an engineering parameter of a multi-cell base station.

According to a third aspect, a reinforcement learning apparatus is provided. The apparatus includes a processor, the processor is coupled to a memory, and the memory is configured to store a computer program or instructions. The processor is configured to execute the computer program or instructions stored in the memory, to perform the method according to the first aspect.

Optionally, the apparatus includes one or more processors.

Optionally, the apparatus may include one or more memories.

Optionally, the memory and the processor may be integrated together or disposed separately.

According to a fourth aspect, a chip is provided. The chip includes a processing module and a communications interface, the processing module is configured to control the communications interface to communicate with the outside, and the processing module is further configured to implement the method according to the first aspect.

According to a fifth aspect, a computer readable storage medium is provided, which stores a computer program (also referred to as instructions or code) for implementing the method according to the first aspect.

For example, when the computer program is executed by a computer, the computer is enabled to perform the method according to the first aspect.

According to a sixth aspect, a computer program product is provided. The computer program product includes a computer program (also referred to as instructions or code). When the computer program is executed by a computer, the computer is enabled to implement the method according to the first aspect. The computer may be a communications apparatus.

### BRIEF DESCRIPTION OF DRAWINGS

FIG. 1 is a schematic diagram of a training process of reinforcement learning;

FIG. 2 is a schematic flowchart of a reinforcement learning method according to an embodiment of this application;

FIG. 3 is a schematic diagram of an aggregation manner of a graph neural network according to an embodiment of this application;

FIG. 4 is a diagram of a system architecture of a reinforcement learning model 100 according to an embodiment of this application;

FIG. 5 is a schematic diagram of comparison between directly observed data and interfered data according to an embodiment of this application;

FIG. 6 is a schematic diagram of a structure learning framework according to an embodiment of this application;

FIG. 7 is a schematic diagram of a process of calculating a model for a “shepherd dog game” according to an embodiment of this application;

FIG. 8 is a schematic diagram of a process of calculating a model for an intelligent agent in a “shepherd dog game” according to an embodiment of this application;

FIG. 9 is a schematic block diagram of a reinforcement learning apparatus 900 according to an embodiment of this application; and

FIG. 10 is a schematic block diagram of a reinforcement learning apparatus 1000 according to an embodiment of this application.

### DESCRIPTION OF EMBODIMENTS

The following describes technical solutions in this application with reference to accompanying drawings.

To describe embodiments of this application, several terms used in embodiments of this application are first described.

Artificial intelligence (artificial intelligence, AI) is a branch of computer science. Artificial intelligence is intended to understand the essence of intelligence and produce a new intelligent machine that can respond in a way similar to human intelligence. Researches in the artificial intelligence field include robots, voice recognition, image recognition, natural language processing, decision-making and inference, human-computer interaction, recommendation and search, and the like.

Machine learning is the core of artificial intelligence. Some people concerned in the industry define machine learning as a process of gradually improving performance P of a model by using a training process E to implement a task T. For example, in order for a model to recognize whether a picture depicts a cat or a dog (task T), to improve accuracy (model performance P) of the model, pictures are continuously provided to the model for the model to learn a difference between a cat and a dog (a training process E). A model finally obtained through the learning process is a product of machine learning. Ideally, the final model has a function of recognizing a cat and a dog in a picture. The training process is a learning process of machine learning.

Machine learning methods include reinforcement learning.

Reinforcement learning (reinforcement learning, RL) is used to describe and resolve the problem of how an intelligent agent (agent) achieves maximum returns or achieves a specific goal by learning of a policy in a process of interacting with an environment.

In reinforcement learning, an intelligent agent (agent) performs learning in a “trial and error” manner, and a behavior of the intelligent agent is guided based on a reward (reward) obtained through interaction with an environment by using an action (action). A goal is to enable the intelligent agent to obtain maximum rewards. Reinforcement learning does not need a training data set. In reinforcement learning, a reinforcement signal (that is, a reward) provided by the environment evaluates a generated action rather than telling a reinforcement learning system how to generate a correct action. An external environment provides very little information. Therefore, the intelligent agent needs to learn from its experience. In this way, the intelligent agent obtains knowledge from an action-evaluation (that is, reward) environment and improves an action solution to adapt to the environment.

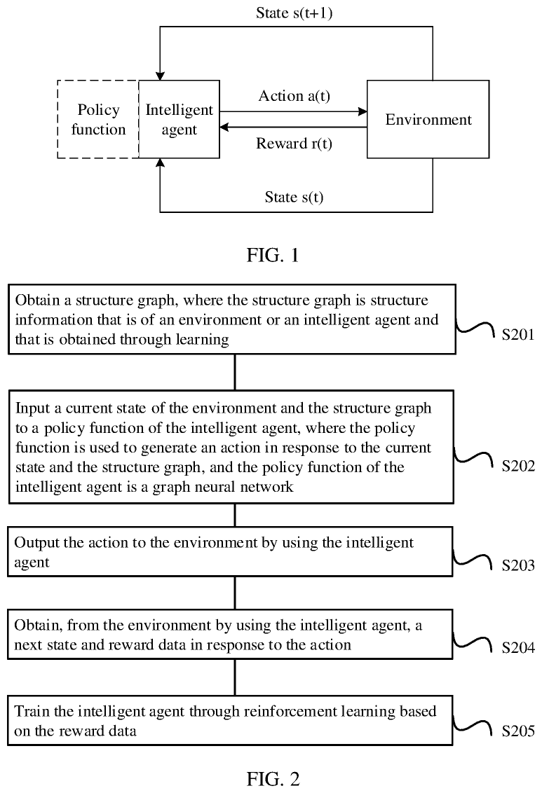

FIG. 1 is a schematic diagram of a training process of reinforcement learning. As shown in FIG. 1, reinforcement learning mainly includes five elements: an intelligent agent (agent), an environment (environment), a state (state), an action (action), and a reward (reward). An input of the intelligent agent is the state, and an output of the intelligent agent is the action.

In an existing technology, a training process of reinforcement learning is as follows: An intelligent agent interacts with an environment for a plurality of times and obtains an action, a state, and a reward of each interaction. The plurality of combinations of (action, state, and reward) are used as training data to train the intelligent agent for one round. The intelligent agent is trained for a next round by using the foregoing process, until a convergence condition is met.

FIG. 1 shows a process of obtaining an action, a state, and a reward in one interaction. A current state s(t) of the environment is input to the intelligent agent, and an action a(t) output by the intelligent agent is obtained. A reward r(t) of a current interaction is calculated based on a related performance indicator of the environment under the action a(t). Until now, the current action a(t), the action a(t), and the reward r(t) of the current interaction are obtained. The current action a(t), the action a(t), and the reward r(t) of the current interaction are recorded for subsequent training of the intelligent agent. A next state s(t+1) of the environment under the action a(t) is further recorded, so as to implement a next interaction of the intelligent agent with the environment.

An intelligent agent (agent) is an entity that can think and interact with an environment. For example, the intelligent agent may be a computer system in a specific environment or a part of the computer system. The intelligent agent may autonomously complete, according to an existing indication or through autonomous learning, a specified goal in an environment in which the intelligent agent is located based on perception of the intelligent agent on the environment and through communication and collaboration with another intelligent agent. The intelligent agent may be software or an entity that combines software and hardware.

A Markov decision process (Markov decision process, MDP) is a common model of reinforcement learning and is a mathematical model for analysis and decision-making issues based on discrete-time stochastic control. In MDP, it is assumed that an environment has a Markov property (in which conditional probability distribution of a future state of the environment depends only on a current state). A decision-maker periodically observes a state of the environment and makes a decision (which may also be referred to as an action) based on the current state of the environment and interacts with the environment to obtain a state and reward of a next step. In other words, a state s(t) observed by the decision-maker at each moment t shifts to a next state s(t+1) under influence of an action a(t) that is performed, and a reward r(t) is fed back. s(t) represents a state function, a(t) represents an action function, r(t) represents a reward, and t represents time.

MDP-based reinforcement learning may include two categories: modeling based on an environment state transition and an environment-free (model free) model. In the former category, a model needs to be built based on an environment state transition, and is usually built based on empirical knowledge or through data fitting. In the latter category, there is no need to build a model based on an environment state transition. Instead, a model constantly improves through exploration and learning in an environment. An actual environment concerned in reinforcement learning is usually more complex than a built model and therefore unpredictable (for example, an environment for a robot or in a go game). Therefore, a reinforcement method based on an environment-free model is usually more favorable for implementation and adjustment.

A variational autoencoder (variational autoencoder, VAE) includes an encoder and a decoder. When the variational autoencoder runs, training data is input to the encoder to generate a group of distributed parameters that describe a latent variable, data is sampled from distribution determined by the latent variable, and the sampled data is output to the decoder. The decoder outputs data that needs to be predicted.

A mask (mask) is a filter function that performs specific filtering on a signal. The mask may perform selective shielding or conversion on an input signal from some dimensions as needed.

A policy function is a behavior rule used by an intelligent agent in reinforcement learning. For example, in a learning process, an action may be output based on a state, and an environment is explored by using the action to update the state. An update of the policy function depends on a policy gradient (policy gradient, PG). The policy function is usually a neural network. For example, the neural network may include a multilayer perceptron (multilayer perceptron).

A graph neural network (graph neural network, GNN) is a deep learning method with structure information and may be used to calculate a current state of a node. Information about the graph neural network is transferred based on a given graph structure, and a state of each node may be updated based on a state of an adjacent node. Specifically, the graph neural network may transfer information about all adjacent nodes to a current node based on a structure graph of the current node and by using a neural network as an aggregation function of the node information, and update a state of the current node accordingly. An output of the graph neural network is states of all nodes.

Structure learning, which may also be referred to as automated graph learning (automated graph learning), is a technology for learning a data structure from observed data according to some standards. For example, the standards may include automated graph learning based on a loss function. The loss function may be used to estimate a degree of inconsistency between a value predicted by a model and an actual value. Common loss functions include a Bayesian information criterion, an Akaike information criterion, and the like. Structure learning models may include a Bayesian network, a linear non-Gaussian acyclic graph model, a neural interaction inference model, and the like. The Bayesian network and the linear non-Gaussian acyclic graph model may learn a causal structure of data from observed data, and the neural interaction inference model may learn a directed graph.

In actual application, a policy function of an intelligent agent usually uses a deep neural network. However, the deep neural network ignores structure information of the intelligent agent or structure information of an environment and lacks interpretability, resulting in low learning efficiency. When there is a large quantity of parameters for training a neural network, if a limited amount of data or a limited quantity of training rounds is given, a gain of the policy function is usually not high enough. One solution is to perform reinforcement learning based on a manually given structure graph. However, this solution is applicable only to a scenario in which obviously a structure of an intelligent agent can be obtained. This solution cannot be implemented when an interacting entity exists in an environment or a structure of an intelligent agent is not obvious.

To resolve the foregoing problem, embodiments of this application provide a reinforcement learning method, so as to improve training efficiency of reinforcement learning.

The reinforcement method in this embodiment of this application may be applied to an environment that includes structure information, for example, a robot control scenario, a gaming environment, or a scenario of optimizing an engineering parameter of a multi-cell base station. The gaming environment may be a gaming scenario that includes structure information, for example, a gaming environment that includes a plurality of interacting entities. For example, the engineering parameter may include an azimuth or a height of a cell.

FIG. 2 is a schematic flowchart of a reinforcement learning method according to an embodiment of this application. The method may be performed by a computer system. The computer system includes an intelligent agent. As shown in FIG. 2, the method includes the following steps.

S201. Obtain a structure graph, where the structure graph includes structure information that is of an environment or the intelligent agent and that is obtained through learning.

The structure information of the environment or intelligent agent (structure of environment or agent) may be structure information of an interacting entity in the environment or structure information of the intelligent agent, and represents some features of the environment or the intelligent agent, for example, a subordination relationship between objects in the environment or a structure of an intelligent robot.

The environment may be a plurality of scenarios that include structure information, for example, a robot control scenario, a gaming scenario, or a scenario of optimizing an engineering parameter of a multi-cell base station.

In the robot control scenario, the structure graph may indicate an interaction relationship between internal nodes of a robot.

The gaming scenario may be a gaming scenario that includes structure information. In the gaming scenario, the structure graph may be used to indicate a connection relationship between a plurality of interacting entities in a gaming environment or a structural relationship between a plurality of nodes in the gaming environment. The gaming scenario may include, for example, a “shepherd dog game” scenario, an “ant smasher game”, and a “billiard game”.

In the scenario of optimizing an engineering parameter of a multi-cell base station, a structure graph may be used to indicate a connection relationship between a plurality of cells or base stations. In a multi-cell base station scenario, a neighbor topology relationship may be ambiguous because an engineering parameter is inaccurate. However, interference reduction for a cell depends on an accurate inter-cell relationship graph. Therefore, an inter-cell relationship graph may be obtained through learning, and the engineering parameter may be adjusted by using the inter-cell relationship graph in a reinforcement learning process, thereby optimizing the engineering parameter.

Optionally, the obtaining a structure graph includes: obtaining historical interaction data of the environment; inputting the historical interaction data to a structure learning model; and learning the structure graph from the historical interaction data by using the structure learning model.

Optionally, the historical interaction data is data generated during interaction between the intelligent agent and the environment. For example, the historical interaction data may include a data sequence of an action that the intelligent agent inputs to the environment and a state that is output by the environment, which may be referred to as a historical action-state sequence for short.

Optionally, the structure learning model may be a model used to extract an internal structure from data. For example, the structure learning model may include a Bayesian network, a linear non-Gaussian acyclic graph model, and a neural interaction inference model in a causal analysis method. The Bayesian network and the linear non-Gaussian acyclic graph model may learn a causal structure of data from observed data, and the neural interaction inference model may learn a directed graph.

In this embodiment of this application, an environmental structure may be obtained from the historical interaction data by using the structure learning model, thereby automatically learning a structure of the environment. In addition, the structure graph is applied to reinforcement learning, to improve efficiency of reinforcement learning.

Optionally, before the historical interaction data is input to the structure learning model, the historical interaction data may be filtered by using a mask, where the mask is used to eliminate impact of an action of the intelligent agent on the historical interaction data.

In some examples, the mask may be used to store information about a node that is interfered with by the intelligent agent. For example, the mask may set a weight of the node that is interfered with to 0 and a weight of other nodes to 1. Data interfered with by an action of the intelligent agent may be filtered out from the historical interaction data by using the mask.

In some examples, a factor of the mask may also be considered in a structure learning process, to improve accuracy of a structure graph obtained through learning. For example, a loss function in structure learning may be calculated by using the mask.

In this embodiment of this application, the historical interaction data may be input to the structure learning model, to obtain the structure graph. The historical interaction data is processed by using the mask, to eliminate impact of an action of the intelligent agent on observed data of the environment, thereby improving accuracy of the structure graph and improving training efficiency of reinforcement learning.

S202. Input a current state of the environment and the structure graph to a policy function of the intelligent agent, where the policy function is used to generate an action in response to the current state and the structure graph, and the policy function of the intelligent agent is a graph neural network.

The graph neural network (graph neural network, GNN) is a deep learning method with structure information and may be used to calculate a current state of a node. Information about the graph neural network is transferred based on a given structure graph, and a state of each node may be updated based on a state of an adjacent node of the node. An output of the graph neural network is states of all nodes.

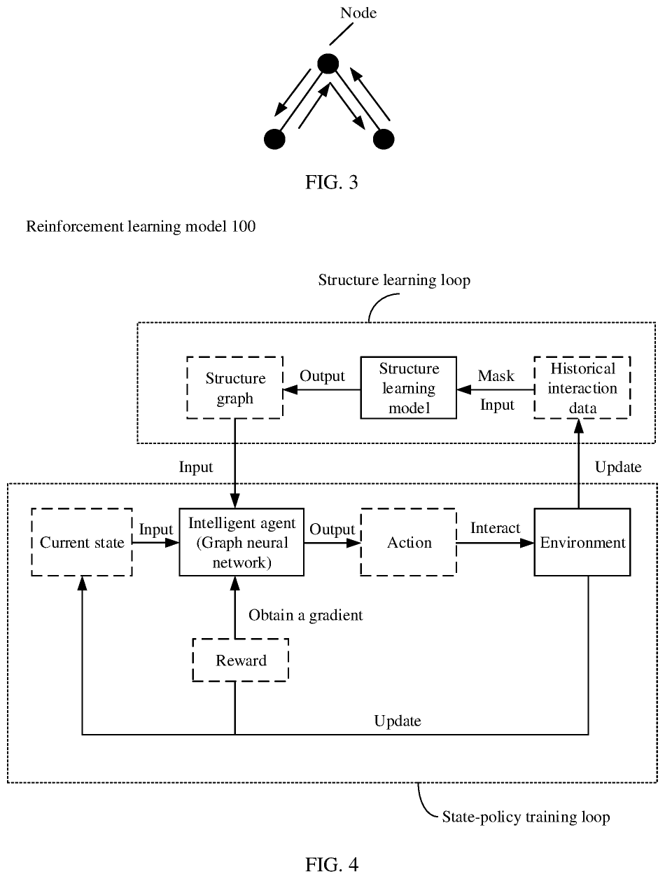

FIG. 3 is a schematic diagram of an aggregation manner of a graph neural network according to an embodiment of this application. As shown in FIG. 3, each black dot represents a node in a structure graph. The graph neural network may transfer information about all adjacent nodes to a current node based on a structure graph of the current node and by using a neural network as an aggregation function of the node information, and update a state of the current node accordingly.

In this embodiment of this application, a graph neural network model is used as the policy function of the intelligent agent, and may include an understanding of an environmental structure, thereby improving efficiency of training the intelligent agent.

Optionally, in different environments, the state may indicate different information.

For example, in the robot control scenario, the state includes a state parameter of at least one joint of a robot, and the state parameter of the joint is used to indicate a current state of the joint. The state parameter of the joint includes but is not limited to at least one of the following: a magnitude of force exerted on the joint, a direction of the force exerted on the joint, momentum of the joint, a position of the joint, an angular velocity of the joint, and an acceleration of the joint.

For another example, in the gaming scenario, the state includes a state parameter of the intelligent agent or a state parameter of an interacting entity in the gaming scenario. The interacting entity is an entity that can interact with the intelligent agent in a gaming environment. In other words, the interacting entity may give a feedback based on an action output by the intelligent agent and change a state parameter of the interacting entity based on the action. For example, in the “shepherd dog game”, the intelligent agent needs to drive a sheep into a sheep fence, and the sheep moves based on an action output by the intelligent agent. In this case, the interacting entity may be the sheep. In the “billiard game”, the intelligent agent needs to move a ball to a destination location through impact. In this case, the interacting entity may be the ball. In the “ant smasher” game, the intelligent agent needs to smash all ants. In this case, the interacting entity may be the ants.

The state parameter of the intelligent agent may indicate a current state of the intelligent agent in the gaming scenario. The state parameter of the intelligent agent may be but is not limited to at least one of the following: location information of the intelligent agent, a movement speed of the intelligent agent, and a movement direction of the intelligent agent.

The state parameter of the interacting entity may indicate a current state of the interacting entity in the gaming environment. The state parameter of the interacting entity may include but is not limited to at least one of the following: location information of the interacting entity, a speed of the interacting entity, color information of the interacting entity, and information about whether the interacting entity has been smashed.

For another example, in the scenario of optimizing an engineering parameter of a multi-cell base station, the state may be the engineering parameter of the base station. The engineering parameter may be a physical parameter that needs to be adjusted during installation or maintenance of the base station. For example, the engineering parameter of the base station includes but is not limited to at least one of the following: a horizontal angle (that is, an azimuth) of an antenna of the base station, a vertical angle (that is, a downtilt) of the antenna of the base station, power of the antenna of the base station, signal sending frequency of the antenna of the base station, and a height of the antenna of the base station.

S203. Output the action to the environment by using the intelligent agent.

Optionally, in different environments, the action may indicate different information.

For example, in the robot control scenario, the action includes a configuration parameter of the at least one joint of the robot. The configuration parameter of the joint is configuration information based on which the joint performs an action. The configuration parameter of the joint includes but is not limited to at least one of the following: the magnitude of the force exerted on the joint and the direction of the force exerted on the joint.

For another example, in the gaming scenario, the action includes an action exerted by the intelligent agent in the gaming scenario. The action includes but is not limited to: the movement direction of the intelligent agent, a movement distance of the intelligent agent, the movement speed of the intelligent agent, a moved-to location of the intelligent agent, and a serial number of an interacting entity on which the intelligent agent acts.

For example, in the “shepherd dog game”, the action may include a serial number of a sheep that the intelligent agent drives. In the “billiard game”, the action of the intelligent agent may be the movement direction of the intelligent agent. In the “ant smasher” game, the action of the intelligent agent may be the movement direction of the intelligent agent.

For another example, in the scenario of optimizing an engineering parameter of a multi-cell base station, the action may include information used to indicate to adjust the engineering parameter of the base station. The engineering parameter may be a physical parameter that needs to be adjusted during installation or maintenance of the base station. For example, the engineering parameter of the base station includes but is not limited to at least one of the following: a horizontal angle (that is, an azimuth) of an antenna of the base station, a vertical angle (that is, a downtilt) of the antenna of the base station, power of the antenna of the base station, signal sending frequency of the antenna of the base station, and a height of the antenna of the base station.

S204. Obtain, from the environment by using the intelligent agent, a next state and reward data in response to the action.

Optionally, in different environments, the reward may indicate different information.

For example, in the robot control scenario, the reward includes state information of the robot. The state information of the robot is used to indicate a state of the robot. For example, the state information of the robot includes but is not limited to at least one of the following: a movement distance of the robot, a movement speed or an average speed of the robot, and a location of the robot.

For another example, in the gaming scenario, the reward includes a completion degree of a target task in the gaming scenario. For example, in the “shepherd dog game”, a reward is a quantity of sheep driven to the sheep fence. In the “ant smasher game”, a reward is a quantity of smashed ants.

For another example, in the scenario of optimizing an engineering parameter of a multi-cell base station, the reward includes a performance parameter of the base station. The performance parameter of the base station is used to indicate performance of the base station. For example, the performance parameter of the base station includes but is not limited to at least one of the following: a signal coverage area of the base station, a coverage signal strength of the base station, quality of a user signal provided by the base station, a signal interference strength of the base station, and a rate of a user network provided by the base station.

S205. Train the intelligent agent through reinforcement learning based on the reward data.

For example, a policy gradient may be obtained based on the reward data, and the graph neural network model may be updated based on the policy gradient, to implement reinforcement training of the intelligent agent.

In this embodiment of this application, a reinforcement learning model architecture is provided, which uses a graph neural network model as the policy function of the intelligent agent and obtains the structure graph of the environment or the intelligent agent through learning. In this way, the intelligent agent can interact with the environment based on the structure graph, to implement reinforcement training of the intelligent agent. In this reinforcement manner, the structure graph obtained through automatic learning and the graph neural network that is used as the policy function are combined. This can shorten a time required for finding a better solution through reinforcement learning, thereby improving training efficiency of reinforcement learning.

In this embodiment of this application, the policy function is interpretable because the structure information is added, so that the structure information of the current intelligent agent or environment can be notably reflected.

In this embodiment of this application, a structure of the environment or intelligent agent is obtained through automatic learning, without requiring artificial experience. The structure obtained through learning can more accurately meet a task requirement than artificial experience and enable a reinforcement learning model to implement end-to-end training. Therefore, the reinforcement learning model can be widely applied to a scenario in which an environmental structure is not obvious, for example, a gaming scenario that includes a plurality of interacting entities.

FIG. 4 is a diagram of a system architecture of a reinforcement learning model 100 according to an embodiment of this application. As shown in FIG. 4, the reinforcement learning model 100 includes two core modules: a state-policy training loop and a structure learning loop.

In the state-policy training loop, a graph neural network is used as a policy function of an intelligent agent and is used to implement interaction between the intelligent agent and an environment. The intelligent agent uses the graph neural network as the policy function. The graph neural network uses a structure graph obtained through learning as a base graph and obtains a gradient by using a reward obtained from the environment, thereby training and updating the graph neural network.

The structure learning loop includes a structure learning model, which is used to obtain a structure graph of the environment or intelligent agent through learning. An input of the structure learning loop is historical interaction data between the intelligent agent and the environment, and an output of the structure learning loop is the structure graph.

With reference to the reinforcement learning model shown in FIG. 4, a specific training process of reinforcement learning includes the following content:

S1. Initialize a reward function, a parameter of the graph neural network, and the structure graph.

In an initial condition, the reinforcement learning model has not started training, and therefore there is no historical action or state. Therefore, the reward function, the parameter of the graph neural network, and the structure graph need to be randomly initialized.

In some examples, the reward function may calculate a gain of a current action of the intelligent agent based on a state of the environment. Generally, a definition of the reward function varies with a specific task. For example, in a scenario of training a robot to walk, the reward function may be defined as a distance by which the robot can move forward.

The parameter of the graph neural network includes an information aggregation function. The information aggregation function is an information transfer function. An input of the information aggregation function is states or features of a current node and a neighboring node of the current node, and an output of the information aggregation function is a next state of the current node. The information aggregation function is usually implemented by using a neural network. For example, for a node i in the graph neural network, an input of the information aggregation function is state information of all neighbors of the current node and adjacent edges thereof, and an output of the information aggregation function is a state of the node i.

S2. The intelligent agent outputs an action to the environment based on the structure graph and a current state that is output by the environment, and obtains an updated state and a reward from the environment.

Step S2 can be understood as a training stage of updating a parameter of a graph neural network model. The intelligent agent outputs an action to the environment, so as to explore the environment. The environment outputs a state in response to the action, to output a state sequence. The environment feeds back a reward to the intelligent agent based on the reward function. The intelligent agent may update the graph neural network based on a reward gradient, to implement reinforcement training of the intelligent agent.

For example, the graph neural network model may be a GraphSAGE model.

In addition, an input of the graph neural network further includes the structure graph obtained by using the structure learning loop. For a specific process of learning the structure graph, refer to step S3.

S3. Learn a structure graph by using the structure learning model, and input the structure graph to the graph neural network in the intelligent agent, to update the graph structure in the graph neural network.

For example, a structure learning process may include the following stages (a) to (c).

(a) Calculate a mask based on an action-state sequence.

The action-state sequence includes a sequence of an action output by the intelligent agent and a state output by the environment. The action-state sequence is data in response to the action of the intelligent agent and is subject to a current policy. Therefore, observed data is not a result of interaction between internal entities in the environment, but is data of some entities subject to the action of the intelligent agent.

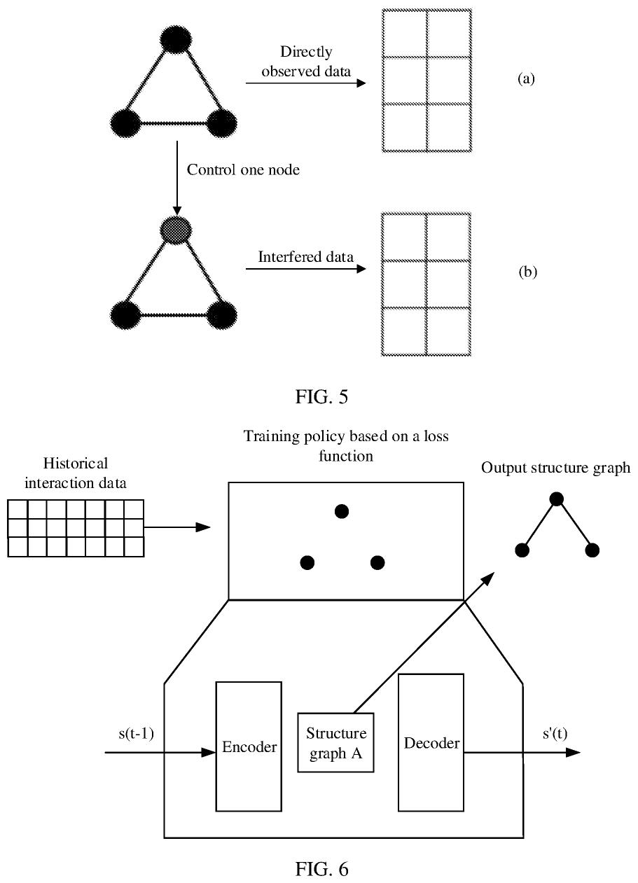

For example, FIG. 5 is a schematic diagram of comparison between directly observed data and interfered data according to an embodiment of this application. (a) in FIG. 5 is a schematic diagram depicting the directly observed data. (b) in FIG. 5 is a schematic diagram depicting data interfered with by an intelligent agent. As shown in FIG. 5, it is assumed that three entities exist in an environment, and each entity is represented by one black node. An action of the intelligent agent affects or controls a node, and data generated therefrom is different from data naturally exchanged between entities in the environment. Data of the controlled node is usually obviously abnormal.

Therefore, a mask can be added to eliminate impact of an action of the intelligent agent on the observed data of the environment.

For example, the mask may be recorded as m(s(t), a(t)), where s(t) represents a state of the environment at a moment t, and a(t) represents an action of the intelligent agent at the moment t. The mask may be used to store information about a node that is interfered with. For example, the mask may set a weight of the node that is interfered with to 0 and a weight of other nodes to 1.

Optionally, data interfered with by the intelligent agent may be filtered out from historical interaction data by using the mask.

(b) Obtain a structure graph by using the structure learning model.

After a mask of the action-state sequence at each moment is obtained, the action-state sequence may be input to the structure learning model, to obtain a structure graph through calculation. The action-state sequence may be data obtained through filtering by using the mask, or may be data that has not undergone filtering by using the mask.

In some examples, a loss function in the structure learning process may be calculated by using the mask.

FIG. 6 is a schematic diagram of a structure learning framework according to an embodiment of this application. As an example for description, a structure learning model of the structure learning framework is a neural interaction inference model. The neural interaction inference model may be implemented by using a variational autoencoder (VAE). As shown in FIG. 6, the neural interaction inference model includes an encoder and a decoder. The neural interaction inference model can learn historical interaction data and learn a structure graph based on a loss function.

Optionally, a structure learning manner may be to predict an error based on a minimized state of a structure graph A. The error predicted based on the minimized state is an error between a state predicted by a calculation model and an actual state, and a model is trained based on an objective to minimize an error.

As shown in FIG. 6, the structure graph A learned based on historical interaction data is output between the encoder and the decoder. The neural interaction inference model may predict a variable based on the structure graph A; then calculate, by using the loss function, a probability that the predicted variable appears; and select, as a structure graph obtained through learning, a corresponding structure graph A obtained when a probability is maximized (that is, a predicted error is minimized).

In the structure learning manner, a state s′(t) at a moment t may be predicted by using a state s(t−1) at a moment t−1. In other words, a predicted variable is s′(t). As shown in FIG. 6, an input of the neural interaction inference model is the state s(t−1) at the moment t−1, and an output of the neural interaction inference model is the state s′(t) at the moment t predicted by the model.

It is assumed that a probability that the predicted variable appears is measured by using Gauss's divergence. Optionally, the probability that the predicted variable appears can be understood as a degree of overlap between a predicted state and an actual state. When the predicted state and the actual state completely overlap, a value of the probability is 1. The probability is represented as follows:

$$P = exp ( - \frac{{‖ {s}^{′} ( t ) - s ( t ) ‖}^{2}}{2 var} ) \qquad ( 1 )$$

In the formula, P represents the probability that the predicted variable appears, var represents a variance of Gaussian distribution, s′(t) represents the state at the moment t predicted by the neural interaction inference model, and s(t) represents an actual state at the moment t.

When the loss function is calculated by using the mask, the probability that the predicted variable appears may be referred to as a mask probability. The mask probability filters out data affected by the intelligent agent. The mask probability is represented as follows:

$${P}_{mask} = exp ( - \frac{{‖ {s}^{′} ( t ) - s ( t ) ) \cdot m ( s ( t ) , a ( t ) ) ‖}^{2}}{2 var} ) \qquad ( 2 )$$

In the formula, Pₘₐₛₖ represents the mask probability, var represents the variance of Gaussian distribution, s′(t) represents the state at the moment t predicted by the neural interaction inference model, s(t) represents the actual state at the moment t, and m(s(t), a(t)) represents the mask.

In some examples, when the probability P or the mask probability Pₘₐₛₖ is maximized, that is, the predicted error is minimized, the structure graph A obtained through learning is a final output structure graph.

(c) Input the structure graph to the graph neural network.

After the structure graph is calculated, the structure graph is output to the graph neural network, to replace an existing graph structure in the graph neural network.

S4. After step S2 is completed, return to step S2 to continue loop execution.

A condition for ending the loop includes at least one of the following: a reward value for an action generated by the policy function reaches a specified threshold, a reward value for an action generated by the graph neural network has converged, or a quantity of training rounds already reaches a specified threshold for a quantity of rounds.

It should be noted that a type of the graph neural network needs to adapt to a type of the structure graph. Therefore, the type of the graph neural network may be adaptively adjusted based on the type of the structure graph obtained through learning or an application scenario. For different types of structure graphs, different graph neural network models may be used. For example, for a directed graph, a GraphSAGE model in the graph neural network may be used. For an undirected graph, a graph convolutional neural network may be used. For a heterogeneous graph, a graph inception model may be used. For a dynamic graph, a recurrent graph neural network may be used. A heterogeneous graph is a graph that includes a plurality of types of edges. A dynamic graph is a structure graph that varies with time.

Accordingly, a setting in the structure learning model may be properly adjusted to implement automatic learning of a structure graph. For example, the structure graph A of the neural interaction inference model in FIG. 6 may be limited to an undirected graph, or the structure graph A may be set to have a plurality of types of edges.

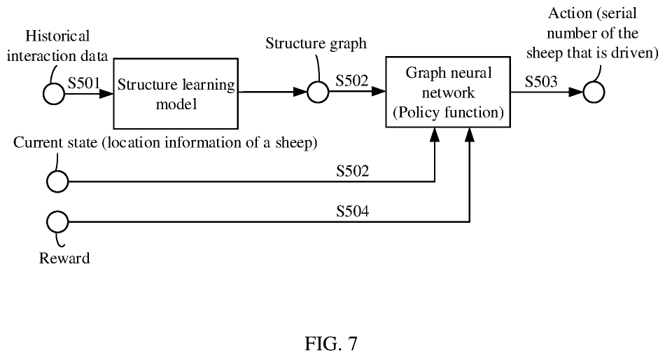

FIG. 7 is a schematic diagram of a process of calculating a model for a “shepherd dog game” according to an embodiment of this application. A scenario of the solution is as follows: Several sheep are randomly placed in two-dimensional space in a specific range, and each sheep has one or no “mother”. A sheep follows or heads for a location of its “mother” under a natural condition. However, if a shepherd dog (which is an intelligent agent) goes near a specific radius range of the sheep, the sheep avoids the shepherd dog and moves in a direction opposite to the dog. The shepherd dog does not know a kinship between the sheep and the “mother”, and the shepherd dog can observe only a location of the sheep. If the sheep enters a sheep fence, the sheep can no longer leave. An objective of the shepherd dog is to drive all sheep to the sheep fence within a shortest time. At each point in time, state information visible to the shepherd dog includes serial numbers and location information of all sheep and location information of the sheep fence. It is assumed that there are n sheep at a moment t. A reward function is represented by using the following formula:

$$r ( s ( t ) , k ) = \frac{1}{n} exp ( - {\sum }_{i = 1}^{n} \frac{\vert s ( t , i ) - k \vert}{2} ) \qquad ( 3 )$$

In the formula, r(s(t),k) represents the reward function, s(t) represents a set of s(t, i), s(t, i) represents coordinates of an i^{th} sheep at a moment t, 1≤i≤n, and k represents coordinates of the sheep fence.

As shown in FIG. 7, a process of training a model for an intelligent agent in the “shepherd dog name” includes the following content:

S501. Input historical interaction data between the shepherd dog and an environment to a structure learning model, and obtain a structure graph learned by the structure learning model.

The historical interaction data may include historical action-state data. The historical action-state data includes an action (recorded as a serial number of a sheep that is driven) output by the shepherd dog and location information (recorded as coordinates of the sheep) of the sheep at each point in time.

S502. Input a current state (namely, the location information of the sheep) and the structure graph to a graph neural network.

The structure graph may be used to indicate a connection relationship, or called a “kinship”, between sheep.

S503. Output an action to the environment based on the graph neural network, to be specific, output the serial number of the sheep driven by the shepherd dog.

S504. Obtain reward information that is fed back by the environment based on the action.

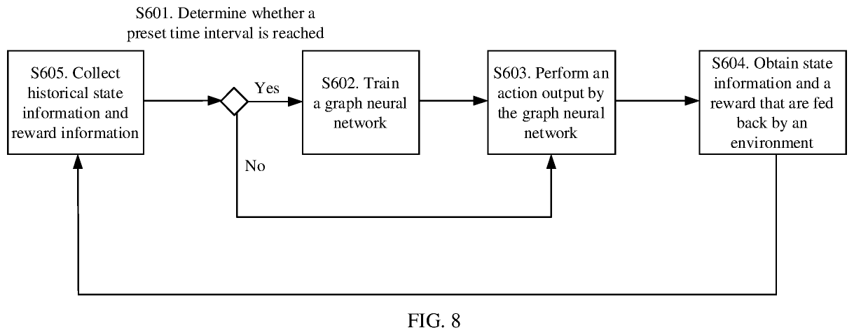

FIG. 8 is a schematic diagram of a process of calculating a model for an intelligent agent in a “shepherd dog game” according to an embodiment of this application. As shown in FIG. 8, in an algorithm implementation process, the intelligent agent may update a neural interaction inference model and a policy function model of a graph neural network based on collected historical interaction information and reward information at a time interval. The specific algorithm implementation process is as follows:

S601. Determine whether a time interval between a moment when the graph neural network was last trained and a current moment has reached a preset time interval. If yes, perform step S602; if no, perform step S603.

The preset time interval may be set based on practice, and is not limited in this embodiment of this application.

S602. Train a graph neural network model based on collected historical interaction information and reward information.

S603. Perform an action output by the graph neural network model, in other words, input the action to an environment.

S604. Obtain reward information that is fed back by the environment.

S605. Collect historical interaction information and reward information, and continue to perform step S601.

In the reinforcement learning method according to embodiments of this application, a structure graph may be automatically learned based on a structure learning model when information about a “kinship” between sheep in an environment is absent. In addition, in the reinforcement learning method, a graph neural network is used as a basic framework for constructing a policy function, and a structure graph is built based on a structure learning model is used, thereby improving training efficiency and a training effect of the policy function.

In embodiments of this application, a structure graph obtained through learning is applied to the graph neural network that is used as the policy function. This can improve target performance of the reinforcement learning method, and further shortens training time required for finding a better solution through reinforcement learning, thereby improving efficiency of the reinforcement learning method.

It should be understood that the application scenarios in FIG. 7 and FIG. 8 are merely examples. The reinforcement learning method of embodiments of this application may also be applied to other scenarios, for example, a gaming scenario of another type, a robot control scenario, or a scenario of optimizing an engineering parameter of a multi-cell base station. For example, a model structure for the robot control scenario may include a HalfCheetah model, an ant model, and a walker2d model.

For example, in a walk2d scenario, during training of a robot, a related node of the robot needs to be controlled to make an action, to make the robot walk farther. A state of the robot includes a metric of each joint. The metric may include, for example, an angle and an acceleration.

For example, in the scenario of optimizing an engineering parameter of a multi-cell base station, a neighbor topology relationship may be unclear because an engineering parameter of a multi-cell base station scenario is indefinite. However, interference reduction for a cell depends on an accurate inter-cell relationship graph. Therefore, the engineering parameter may be adjusted by learning an inter-cell relationship graph and by using the inter-cell relationship graph in a reinforcement learning process, thereby optimizing the engineering parameter. In the reinforcement learning process, a change to an engineering parameter of a cell may be used as a state, and a policy gradient may be obtained by optimizing a gain (for example, a network rate), to implement reinforcement training of an intelligent agent.

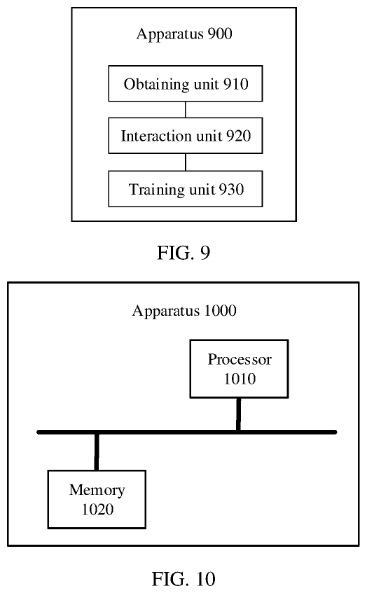

The foregoing describes the reinforcement learning method in embodiments of this application with reference to FIG. 1 to FIG. 8. The following describes a reinforcement learning apparatus in embodiments of this application with reference to FIG. 9 and FIG. 10.

FIG. 9 is a schematic block diagram of a reinforcement learning apparatus 900 according to an embodiment of this application. The apparatus 900 may be configured to perform the reinforcement learning method provided in the foregoing embodiments. For brevity, details are not described herein again. The apparatus 900 may be a computer system, may be a chip or a circuit in a computer system, or may be referred to as an AI module. As shown in FIG. 9, the apparatus 900 includes:

an obtaining unit 910, configured to obtain a structure graph, where the structure graph includes structure information that is of an environment or an intelligent agent and that is obtained through learning;

an interaction unit 920, configured to input a current state of the environment and the structure graph to a policy function of the intelligent agent, where the policy function is used to generate an action in response to the current state and the structure graph, and the policy function of the intelligent agent is a graph neural network; the interaction unit is further configured to output the action to the environment by using the intelligent agent; and the interaction unit 920 is further configured to obtain, from the environment by using the intelligent agent, a next state and reward data in response to the action; and

a training unit 930, configured to train the intelligent agent through reinforcement learning based on the reward data.

FIG. 10 is a schematic block diagram of a reinforcement learning apparatus 1000 according to an embodiment of this application. The apparatus 1000 may be configured to perform the reinforcement learning method provided in the foregoing embodiments. For brevity, details are not described herein again. The apparatus 1000 includes a processor 1010. The processor 1010 is coupled to a memory 1020. The memory 1020 is configured to store a computer program or instructions. The processor 1010 is configured to execute the computer program or the instructions stored in the memory 1020, to perform the method in the foregoing method embodiment.

Embodiments of this application further provide a computer readable storage medium, which stores computer instructions for implementing the method in the foregoing method embodiment.

For example, when the computer program is executed by a computer, the computer is enabled to perform the method in the foregoing method embodiment.

Embodiments of this application further provide a computer program product including instructions. When the instructions are executed by a computer, the computer is enabled to implement the method in the foregoing method embodiment.

A person of ordinary skill in the art may be aware that, in combination with examples described in embodiments disclosed in this specification, units and algorithm steps may be implemented by electronic hardware or a combination of computer software and electronic hardware. Whether functions are performed by hardware or software depends on particular applications and design constraints of technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In several embodiments provided in this application, it should be understood that the disclosed system, apparatus, and method may be implemented in another manner. For example, the described apparatus embodiments are merely examples. For example, division into units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between apparatuses or units may be implemented in electrical, mechanical, or another form.

The units described as separate parts may or may not be physically separate, and parts displayed as units may or may not be physical units, that is, may be located in one position, or may be distributed on a plurality of network units. Some or all of the units may be selected based on actual requirements to achieve the objectives of solutions of embodiments.

In addition, functional units in embodiments of this application may be integrated into one processing unit, or each of the units may exist alone physically, or two or more units may be integrated into one unit.

When the functions are implemented in a form of a software functional unit and sold or used as an independent product, the functions may be stored in a computer readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in embodiments of this application. The foregoing storage medium includes various media that can store program code, such as a USB flash drive, a removable hard disk, a read-only memory (Read-Only Memory, ROM), a random access memory (Random Access Memory, RAM), a magnetic disk, and an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A reinforcement learning method, comprising:
obtaining a structure graph, wherein the structure graph comprises structure information that is of an environment or an intelligent agent and that is obtained through learning;
inputting a current state of the environment and the structure graph to a policy function of the intelligent agent, wherein the policy function is used to generate an action in response to the current state and the structure graph, and the policy function of the intelligent agent is a graph neural network;
outputting the action to the environment by using the intelligent agent;
obtaining, from the environment by using the intelligent agent, a next state and reward data in response to the action; and
training the intelligent agent through reinforcement learning based on the reward data.

2. The method according to claim 1, wherein the obtaining a structure graph comprises:
obtaining historical interaction data of the environment;
inputting the historical interaction data to a structure learning model; and
learning the structure graph from the historical interaction data by using the structure learning model.

3. The method according to claim 2, wherein before the inputting the historical interaction data to a structure learning model, the method further comprises:
filtering the historical interaction data by using a mask, wherein the mask is used to eliminate impact of an action of the intelligent agent on the historical interaction data.

4. The method according to claim 2, wherein the structure learning model calculates a loss function by using the mask, the mask is used to eliminate impact of an action of the intelligent agent on the historical interaction data, and the structure learning model learns the structure graph based on the loss function.

5. The method according to claim 2, wherein the structure learning model comprises any one of the following: a neural interaction inference model, a Bayesian network, and a linear non-Gaussian acyclic graph model.

6. The method according to claim 1, wherein the environment is a robot control scenario.

7. The method according to claim 1, wherein the environment is a gaming environment comprising structure information.

8. The method according to claim 1, wherein the environment is a scenario of optimizing an engineering parameter of a multi-cell base station.

9. A reinforcement learning apparatus, comprising:
a memory, configured to store executable instructions; and
a processor, configured to call and execute the executable instructions in the memory, to perform operations of:
obtaining a structure graph, wherein the structure graph comprises structure information that is of an environment or an intelligent agent and that is obtained through learning;
inputting a current state of the environment and the structure graph to a policy function of the intelligent agent, wherein the policy function is used to generate an action in response to the current state and the structure graph, and the policy function of the intelligent agent is a graph neural network;
outputting the action to the environment by using the intelligent agent;
obtaining, from the environment by using the intelligent agent, a next state and reward data in response to the action; and
training the intelligent agent through reinforcement learning based on the reward data.

10. The apparatus according to claim 9, wherein the obtaining a structure graph comprises:
obtaining historical interaction data of the environment;
inputting the historical interaction data to a structure learning model; and
learning the structure graph from the historical interaction data by using the structure learning model.

11. The apparatus according to claim 10, wherein the processor further configured to perform operation of:
filtering the historical interaction data by using a mask, wherein the mask is used to eliminate impact of an action of the intelligent agent on the historical interaction data.

12. The apparatus according to claim 10, wherein the structure learning model calculates a loss function by using the mask, the mask is used to eliminate impact of an action of the intelligent agent on the historical interaction data, and the structure learning model learns the structure graph based on the loss function.

13. The apparatus according to claim 10, wherein the structure learning model comprises any one of the following: a neural interaction inference model, a Bayesian network, and a linear non-Gaussian acyclic graph model.

14. The apparatus according to claim 9, wherein the environment is a robot control scenario.

15. The apparatus according to claim 9, wherein the environment is a gaming environment comprising structure information.

16. The apparatus according to claim 9, wherein the environment is a scenario of optimizing an engineering parameter of a multi-cell base station.

17. A computer readable storage medium, wherein the computer readable storage medium stores program instructions, and when the program instructions are run by a processor, the method according to claim 1 is implemented.
